(19) United States
(12) Patent Application Publication
(10) Pub. No.: US 2011/0215089 A1
(43) Pub. Date: Sep. 8, 2011

(54) Electromagnetic Induction Air Heater System with Moving Heating Element And Methods

(76) Inventor: Bernardo Alberto Garza, Nuevo Laredo (MX)

(21) Appl. No.: 13/149,847

(22) Filed: May 31, 2011

(30) Foreign Application Priority Data
Sep. 8, 2010 (MX) MX/U/2010/000352

(51) Int. Cl. H05B 6/04

(52) U.S. Cl. 219/628

(57) ABSTRACT

An electromagnetic induction air heater system (10) includes a conductive element (1), a driver (4) coupled to the conductive element (1), an induction element (2) positioned close to the conductive element (1), and a power supply (3) coupled to the induction element (2) and the driver (4). Specifically, the driver (4) applies an angular velocity to the rotate the conductive element (1) about a rotational axis (5). The power supply (3) provides electric current to the induction element (2) to generate a magnetic field about the induction element (2) such that the conductive element (3) heats as it rotates within the magnetic field to transfer heat to warm the cold air flow streams (7). The cold air flow streams (7) are circulated about the surface of the conductive element (1) and directed by the moving conductive element (1) to generate warm air flow streams (8) from the conductive element (1).

### BACKGROUND OF THE INVENTION

1. Cross Reference To Related Applications

This application is a Non-Provisional Application which claims benefit under 35 U.S.C. §119(a) from a Non-Provisional Patent Application Ser. No. MX/u/2010/000352 filed in the Republic of Mexico on August 09, 2010 entitled “Magnetic Induction Air Heater with a Revolving Conductive Element for Warming Air of an Electrical Heater”, by inventor Bernardo Alberto Garza Delgado, the entire contents of the above referenced Application is hereby incorporated by reference as if fully set forth herein.

2. Technical Field

The application generally relates to air heating. More particularly, but not by way of limitation, the application relates to an electromagnetic induction air heater system (10) and method featuring a conductive element (3) that heats as it rotates within the magnetic field to transfer heat to warm the cold air flow streams (7) that are circulated by the moving conductive element (1) about the surface of the conductive element (1) and directed by the moving conductive element (1) to generate warm air flow streams (8) from the conductive element (1).

3. Description of Related Art

Every day, people demand a greater standard for comfortable living, and there has been a major need to support a climate of favorable and clean living interiors, especially in the winter season. Therefore, people are more and more interested in emission-free warm-air electrical heaters that are even more favorable than conventional heaters that use either heated oil or the gas as fuel that unfortunately consumes oxygen and generates expressed waste gases from these combustion processes. In that air warming electrical heaters require time to provide an output of warm air, such heaters can be safely mounted to a wall or ceiling and provide less risk for accidents as with rapidly heating types of heaters. Because there is no consumption of oxygen to generate heat, air warming electric heaters enable one to comfortably and safely provide warm air in confined spaces.

Conventional warm-air electrical heaters control the temperature of a heating element through heating methods based on the “Joule effect” of applying an electric current directly to an electrically resistive heating element over time, such as an heating element composed of alloy wires, such as among others NICHROME; ceramics using thin film resistance metal on the surface of ceramics; and of coal using the electrical resistance of coal. Nevertheless, ordinary conventional electric heaters both generally feature structural components that have low thermal conductivity and generally provide for a small area for facilitating contact between the surrounding air and a heating element, thereby yielding a low energy output capacity.

Unfortunately, most electric heaters that employ the Joule effect are energy inefficient as they consume a significant quantity of electrical energy input and provide heat energy output at an energy deficit. Inasmuch, electric heaters are rarely used for most common industrial and commercial heating purposes with the exception of electric space heaters for domestic use that is primarily used in highly localized areas around the home. Nevertheless, there is a significant, continuing demand for energy efficient electric heaters that provide a climate that is favorable toward better living standards to enjoy while either at work or recreating.

Therefore, a need exists for a system and method for an electromagnetic induction air heater system and method having a moving heating element. There is also a need for an energy efficient, low greenhouse gas emitting electric air heater providing an improved heating element and method of use.

### SUMMARY OF THE INVENTION

Aspects of the present invention are found in an electromagnetic induction air heater system (10) includes a conductive element (1), a driver (4) coupled to the conductive element (1), an induction element (2) positioned close to the conductive element (1), a power supply (3) coupled to the induction element (2) and the driver (4), and a temperature control system (6) coupled to the power supply.

The conductive element (1) warms cold air flow streams (7) received by the electromagnetic induction air heater system (10). In particular, the driver (4) applies an angular velocity to the rotate the conductive element (1) about a rotational axis (5). The power supply (3) provides electric current to the induction element (2) to generate a magnetic field about the induction element (2) such that the conductive element (3) heats as it rotates within the magnetic field to transfer heat to warm the cold air flow streams (7). Specifically, the cold air flow streams (7) are circulated about the surface of the conductive element (1) and directed by the moving conductive element (1) to thus generate warm air flow streams (8) from the conductive element (1). The temperature control system (6) regulates the high temperature heating of the conductive element (1) turning within the field.

In one aspect, an air heater by magnetic induction uses a revolving conductive element for the warming of air of an electromagnetic induction air heater system. The revolving conductive element is warmed, when a field of high frequency alternating current is applied to an induction element that is positioned adjacent or in the plane parallel to the conductive element as the conductive element turns on its own rotational axis, at a constant angular velocity or at a variable angular velocity, establishing on the surface of the revolving conductive element a very high temperature warming controlled by a temperature control system, cold air flow streams are circulated about the surface of the conductive element and directed by the moving conductive element to thus generate warm air flow streams from the conductive element, thereby providing a major efficiency in warming colder air as compared with traditional electric heaters with statically positioned heating elements.

In at least one aspect, an electromagnetic induction air heater system provides a revolving conductive element for the warming of air. Eddy or “Foucault” currents arise throughout the revolving conductive element while within an induced magnetic field to significantly heat the surface of the conductive element to warm, via heat transfer, the surrounding cooler air. The magnetic induction field is applied by an induction element to the conductive element that is rotating within the field. Optionally, the induction winding may be rendered in various configurations. The conductive element turns on its own rotational axis, at either a constant angular velocity or at a variable angular velocity. establishing on the surface of the revolving conductive element a very high temperature warming controlled by a temperature control system, the cold air is circulated and directed by the moving conductive element to thus obtain warmer air from the conductive element, thereby providing a major efficiency in warming colder air as compared with traditional electric heaters with static heating elements.

In one further aspect, an electromagnetic induction air heater system (10) uses a revolving conductive element for the warming the surrounding air, including an induction element (2), a conductive element (1) that is rendered a variety of configurations for both heating and directing hot air away from the electromagnetic induction air heater system (10) such as, among others, a round plate, a plurality of fan blades, an arrangement of shaped blades that form a cylindrical shape, a round helix, and a square helix, etc., a power supply that includes a generating source of high frequency alternating current (3) to provide current to the induction element (2) that is connected to the generator. The conductive element (1) either turns on its own rotational axis either adjacent to (5) or in a plane parallel to the induction element (2) to thereby generate a highly heated surface on the conductive element (1). Illustratively, in one embodiment, moving the conductive element near the induction element (2) creates a surface temperature of up to 250° C. or 482° F. on the conductive element (1). A temperature control system (6) is used for the monitoring of the warming of the conductive element (1). The temperature control system (6) includes at least one computer-based processor for regulating the among of high frequency alternating current supplied by the generating source (3) to obtain the optimal energy efficiency and yield in the warming of the surrounding air.

Other aspects, advantages, and novel features of the present invention will become apparent from the detailed description of the present invention when considered in conjunction with the accompanying drawings.

### DESCRIPTION OF THE DRAWINGS

The present invention is illustrated by way of example and not by limitation in the accompanying figures, in which like references indicate similar elements, and in which:

FIG. 1 is a schematic view of one embodiment of an electromagnetic induction air heater system (10) using a revolving conductive element for the warming the surrounding air of an electrical heater that consists of the following, a conductive element illustratively shown in the shape of round plate (1) turning on its own rotational axis, an induction element (2) in an illustrative form of a flat circular spiral, a power supply that includes a generating source of high frequency alternating current (3), a driver such as a motor or similar mechanism (4) a rotational axis of the conductive element (5), a temperature control system (6), cold air flow streams (7) warm air flow streams (8);

FIG. 2 is a schematic view of one embodiment of an electromagnetic induction air heater system (10) using a revolving conductive element for the warming the surrounding air of an electrical heater that consists of the following, a first conductive element of a plurality of conductive elements illustratively shown in the shape of round plate (1) turning on its own rotational axis, a second conductive element of a plurality of conductive elements illustratively shown in the form of a plurality of shaped blades (9) turning on its own rotational axis, an induction element (2) in an illustrative form of a flat circular spiral, a power supply that includes a generating source of high frequency alternating current (3), a driver such as a motor or similar mechanism (4) a rotational axis of the conductive element (5), a temperature control system (6), cold air flow streams (7) warm air flow streams (8); and

FIG. 3 is a schematic view of one embodiment of an electromagnetic induction air heater system (10) using a revolving conductive element (1) for the warming the surrounding air of an electrical heater that consists of the following parts, a conductive element illustratively shown as an arrangement of shaped blades that form a cylindrical shape (1) turning on its own rotational axis, an induction element (2) in an illustrative form of a flat circular spiral, a power supply that includes a generating source of high frequency alternating current (3), a driver (4) such as a motor or similar mechanism, a rotational axis of the conductive element (5), a temperature control system (6), cold air flow streams (7) warm air flow streams (8).

Skilled artisans appreciate that elements in the Figures are illustrated for simplicity and clarity and have not necessarily been drawn to scale. For example, the dimensions of some of the elements in the Figures may be exaggerated relative to the other elements to help improve understanding of the embodiments of the present invention.

### DETAILED DESCRIPTION

For a more complete understanding of the present invention, preferred embodiments of the present invention are illustrated in the Figures Like numerals being used to refer to like and corresponding parts of the various accompanying drawings. It is to be understood that the disclosed embodiments are merely exemplary of the invention, which may be embodied in various forms.

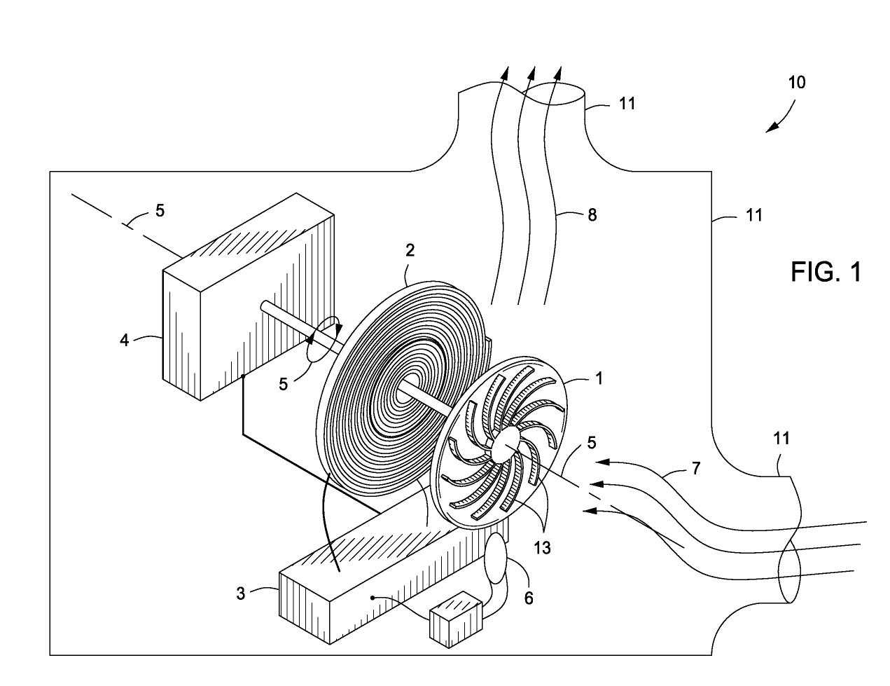

As generally depicted in FIGS. 1-3, an electromagnetic induction air heater system (10) includes a conductive element (1), a driver (4) coupled to the conductive element (1), an induction element (2) positioned close to the conductive element (1), a power supply (3) coupled to the induction element (2) and the driver (4), and a temperature control system (6) coupled to the power supply.

The conductive element (1) warms cold air flow streams (7) received by the electromagnetic induction air heater system (10). In particular, the driver (4) applies an angular velocity to the rotate the conductive element (1) about a rotational axis (5). The power supply (3) provides electric current to the induction element (2) to generate a magnetic field about the induction element (2) such that the conductive element (3) heats as it rotates within the magnetic field to transfer heat to warm the cold air flow streams (7). Specifically, the cold air flow streams (7) are circulated about the surface of the conductive element (1) and directed by the moving conductive element (1) to thus generate warm air flow streams (8) from the conductive element (1). The temperature control system (6) regulates the high temperature heating of the conductive element (1) turning within the field.

The conductive element (1) is configured for both engaging the cold air flow streams (7) to contact the most surface area provided by heated surface of the conductive element (1) for optimal heat transfer to the cold air flow streams (7) as well as to direct the resulting warm air flow streams (8) from the surface of the conductive element (1) and away from the electromagnetic induction air heater system (10) in a predetermined manner, such as among others in a directional manner, a radial direction, and a convectional manner. Accordingly, the conductive element (1) promotes energy efficiency by heating the air with increased surface area thus requiring relatively less alternating current supply from the power supply (3). The conductive element (1) heats the air without combustion process to thus enhance the quality of the earth's environment by markedly eliminating carbon-based and other greenhouse gas emissions from the process of heating the surrounding air.

In one embodiment, the conductive element (1) comprises a planar geometrical shape. In one embodiment, the conductive element (1) comprises a frame. In one embodiment, the conductive element (1) comprises a volumetric geometrical shape. In one embodiment, the conductive element (1) comprises a volumetric geometrical shape with groves. In one embodiment, the conductive element (1) comprises a volumetric geometrical shape with perforations. In one embodiment, the conductive element (1) comprises a hollowed volumetric geometrical shape. In one embodiment, the conductive element (1) includes at least one blade configuration. In one embodiment, the conductive element (1) comprises a cylindrical shape for domestic use.

Furthermore, to enhance conductivity, the conductive element (1) in one embodiment is composed of a magnetic material having a high level of magnetic permeability to increase the efficacy of conversion between electrical and heat energy as applied to the induction process, such as among others a metallic and a ceramic material. The conductive element (1) in one embodiment is composed of at least one material having a high thermal conductivity, such as among others at least one metallic material. The conductive element (1) in one embodiment is composed of at least one alloy material having a high thermal conductivity, such as among others at least one metallic alloy material. The conductive element (1) in one embodiment is composed of ceramic material(s).

The conductive element (1) in one embodiment is composed of a combination of at least one material having a high thermal conductivity and at least one material with a high level of magnetic permeability to increase the efficacy of conversion between electrical and heat energy. Illustratively, in at least one embodiment, the conductive element (1) is composed of materials selected from the group consisting of: a magnetic material having a high level of magnetic permeability to increase the efficacy of conversion between electrical and heat energy as applied to the induction process, such as among others a metallic and a ceramic material; at least one material having a high thermal conductivity, such as among others at least one metallic material; at least one alloy material having a high thermal conductivity, such as among others at least one metallic alloy material; and a combination of at least one material having a high thermal conductivity and at least one material with a high level of magnetic permeability to increase the efficacy of conversion between electrical and heat energy.

Inasmuch an unexpected result of continuously moving the conductive element (1) about its own rotational axis is that the efficacy of conversion between electrical and heat energy markedly increases the heating effects on the surface of the conductive element (1) due to magnetic induction because there is less high frequency electrical power needed to supply the induction element (2), than with what was initially required, to maintain the high temperature surface of the rotating conductive element (1) to heat the cold air flow streams (1) and direct the resulting warm air flow streams (8) away from the conductive element (1).

In one embodiment, the induction element (2) is configured to conform to the shape of the conductive element (1) to optimize generation of eddy currents on the conductive element (1) while rotating within the magnetic field generated by the induction element (2). In one embodiment, the induction element (2) comprises a flat induction winding as illustrated in FIGS. 1-3. In one embodiment, the induction element (2) is rendered in a variety of general configurations selected from the group consisting of: an induction winding, a flat induction winding, a round plate, a flan blade, a plurality of fan blades, at least one blade configuration, a round plate with at least one fan blade, a cylindrical core with a plurality of fan blades extending from the core, a volumetric geometrical shape with a plurality of fan blades extending from the core, a planar geometrical shape, a frame, a flat geometrical form such as an elliptical, circular, rectangular, triangular form, a volumetric geometrical shape, a volumetric geometrical shape with groves, a volumetric geometrical shape with perforations, a hollowed volumetric geometrical shape, a round helix, and a square helix.

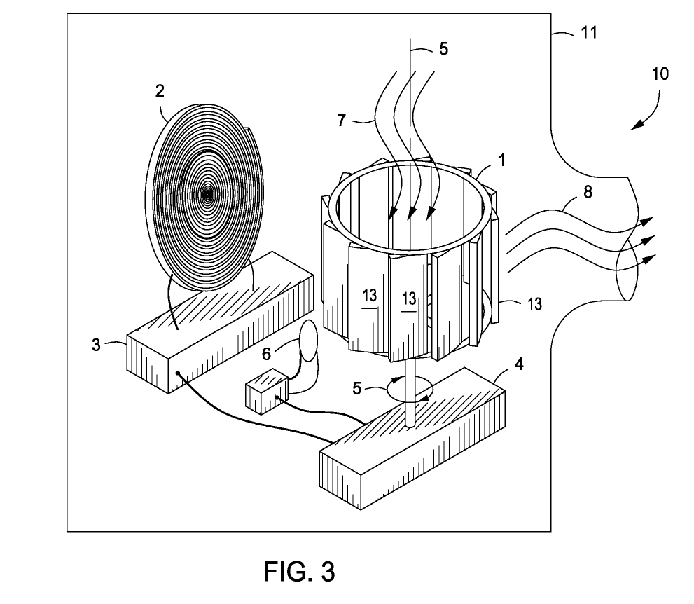

With reference to FIGS. 1-3, at least one embodiment of a conductive element (1) for an electromagnetic induction air heater system (10) is appreciated as follows. The conductive element (1) includes at least one directional fin (13) that provides increased surface area for cold air flow stream (7) contact with the conductive element (1). The at least one directional fin (13), in one embodiment, draws cold air flow streams (7) through the electromagnetic induction heater system (10). In at least one embodiment, the electromagnetic induction air heater system (10) includes a heater system body (11) for housing the electromagnetic induction air heater system (10). As illustrated in the embodiment of FIG. 3, the heater system body (11) is configured to direct warm air flow streams (8) from the conductive element (1) about a predetermined path. As illustrated in the embodiment of FIG. 1, the heater system body (11) is configured to direct cold air flow streams (7) to the conductive element (1) about a predetermined path.

In operation, the conductive element (1) warms the cold air flow streams (7) received by the electromagnetic induction air heater system (10) to generate warm air flow streams (8). In particular, the at least one directional fin (13) facilitates generation of eddy or “Foucault” currents that arise throughout the conductive element (1) to raise the temperature about the surface of conductive element (1) to generate warm air flow streams (8) as the cold air flow streams (7) contact the at least one directional fin (13) and remaining surface of the conductive element (1). The at least one directional fin (13) facilitates heat transfer to the cold air flow streams (7).

The at least one directional fin (13) directs the generated warm air flow streams (8) outwardly from the electromagnetic induction air heater system (10) to the surrounding air. In one embodiment, the at least one fin (13) directs the warm air flow streams (8) about a predetermined path created by the configuration the at least one fin (13) as the conductive element (1) rotates within the magnetic field.

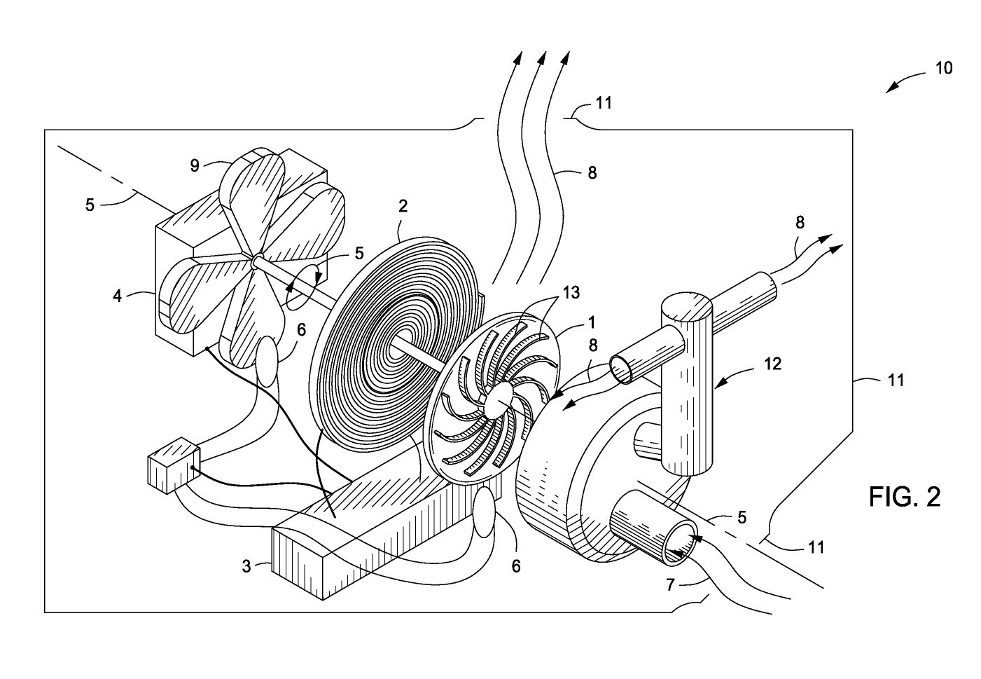

The electromagnetic induction heater system (10) further includes at least one nonconductive element (12) that is aligned with the rotational axis (5). In at least one embodiment, the at least one nonconductive element (12) comprises a directional discharger for channeling the warm air flow streams (8) away from the conductive element (1) in a predetermined direction. As illustrated in FIG. 2, the at least one nonconductive element (12) comprises a directional discharger for perpendicularly discharging warm air flow streams (8) from the electromagnetic induction air heater system (10) relative to the conductive element (1).

The conductive element (1) further includes a driver (4), coupled to the conductive element (1), for applying an angular velocity to the rotate the conductive element (1) about a rotational axis (5). The conductive element (3) heats as it rotates within a magnetic field to transfer heat to warm the cold air flow streams (7). An induction element (2), positioned close to the conductive element (1), generates a magnetic field for receiving the rotating conductive element (1).

The electromagnetic induction air heater system (10) further includes a power supply (3), coupled to the induction element (2), that provides electric current to the induction element (2) to generate a magnetic field about the induction element (2). A temperature control system (6) regulates the high temperature heating of the conductive element (1) turning within the field, as the cold air flow streams (7) are circulated about the surface of the conductive element (1) and directed by the moving conductive element to thus generate warm air flow streams (8) from the conductive element (1). The temperature control system (6) and the driver (4) each coupled to the power supply (3).

With reference to FIGS. 1-3, a method for warming cold air flow streams (8) with at least one embodiment of a conductive element (1) is appreciated as follows. A driver (4), coupled to the conductive element (1), applies an angular velocity to rotate the conductive element (1) about a rotational axis (5). An electric current is supplied to an induction element (2) to generate a magnetic field about the induction element (2). The conductive element (1) is heated with eddy or “Foucault” currents as the conductive element (1) rotates within the magnetic field. The cold air streams (7) are drawn to the conductive element (1) and heat is transferred from the conductive element (1) to warm the cold air flow streams (7). The moving conductive element (1) circulates the cold air flow streams (7) about the surface of the conductive element (1) to generate warm air flow streams (8) and directs the warm air flow streams (8) from the conductive element (1) with the moving conductive element (1).

Operatively, a conductive element (1) turns about its axis of rotation (5), via a driver (4), close to the induction element (2). The conductive element (1) is warmed by magnetic induction. In particular, an magnetic field is generated by a plurality of coils provided by the induction element (2) with each coil receiving high frequency alternating current, from the power supply (3), therethrough. The conductive element (5) is positioned either near or within the magnetic field such that a current of induction flows from the induction element (2) onto the surface of the conductive element (1) at a superficial depth to thus establish Joule effect heating on the surface of the conductive element (1). Particularly, when a high frequency current of alternating current is applied to the induction element (2) to create a magnetic field by which the conductive element (1) rotates therein and about the rotational axis (5), eddy or “Foucault” currents arise throughout the conductive element (1) in that portions of the conductive element (1) that are furthest from the rotational axis (5) cut more lines of magnetic force with the established field than portions of the conductive element (1) that are closest to the rotational axis (5). Accordingly, as the induced electromotive force is not uniform within the conductive element (1), the outer surface of the conductive element (1) heats up significantly more than other portions of the conductive element (1) as the induced electromotive force establishes eddy currents between the points of greatest and least potential such that eddy currents consume the most amount of energy at the surface of the conductive element (1) to thus cause a significant rise in temperature about the surface. Heating with an induced magnetic field are well known in the industry, such as methods for industrial smelting and annealing, and each time increasingly extends to other applications such as those requiring electrical heating for cooking.

In general, the electromagnetic induction air heater system (10) features a temperature control system (6) that regulates the temperature of the rotating conductive element (1) to provide warm air flow streams (8) at a desired temperature. In particular, the temperature control system (6) is coupled to the power supply (3). In one embodiment, the power supply (3) is coupled to the induction element (2) such that temperature feedback from the temperature control system (6) regulates the amount of high frequency alternating current supplied to the induction element (2) from the power supply (3) to maintain the desired temperature of the warm air flow streams (8) created by the conductive element (1). In one embodiment, the power supply (3) is coupled to the driver (4) such that temperature feedback from the temperature control system (6) regulates the rotational acceleration provided by the driver (4) to the conductive element (1), as power is regulated from the power supply (3) to the driver (4) based on the temperature feedback, to maintain the desired temperature of the warm air flow streams (8) created by the conductive element (1).

The invention will be described with respect to the corresponding figures as follows. Each of the figures from FIGS. 1-3 show various illustrative embodiments of an electromagnetic induction air heater system (10) having a rotating conductive element (1) for converting cold air flow streams (7) to warm airflow streams (8).

The embodiment of FIG. 1 illustrates a conductive element (1) that rotates about a corresponding rotational axis (5) at different rotational velocities and varied rates of angular acceleration. The conductive element (1) for the embodiment of FIG. 1 is composed of material selected from the group consisting of:

magnetic material with a high level of magnetic permeability, a metallic material featuring high level of thermal conductivity, an alloy material featuring both a high level of thermal conductivity and magnetic permeability, and a metallic material featuring both a high level of thermal conductivity and magnetic permeability. The conductive element (1) is rendered a variety of configurations for both heating and directing hot air away from the electromagnetic induction air heater system (10) such as, among others, a round plate, a plurality of fan blades, an arrangement of shaped blades that form a cylindrical shape, a round helix, and a square helix, etc. Illustratively, in at least one embodiment, the conductive element (1) is rendered a variety of general configurations selected from the group consisting of: a round plate, a flan blade, a plurality of fan blades, an arrangement of shaped blades that form a cylindrical shape, at least one blade configuration, a round plate with at least one fan blade, a cylindrical core with a plurality of fan blades extending from the core, a volumetric geometrical shape with a plurality of fan blades extending from the core, a planar geometrical shape, a frame, a volumetric geometrical shape, a volumetric geometrical shape with groves, a volumetric geometrical shape with perforations, a hollowed volumetric geometrical shape, a round helix, and a square helix.

The conductive element (1) and an induction element (2) are positioned such that the induction element (2) is placed in either an adjacent plane with or in parallel to the conductive element (1). The power supply (3) is coupled to the induction element (2). As electric current is applied by the power supply (3) to the induction element (2), the conductive element (1) turns on its own rotational axis (5) by the driver (4), at a constant angular velocity or at a variable angular velocity. The magnetic induction field applied by the induction element (2) to the conductive element (1) rotating within the field establishes on the surface of the revolving conductive element (1) a very high temperature warming that is regulated by a temperature control system (6) to avoid, among other applications, catastrophic heating of the element driver (5) coupled to the conductive element (1). The cold air flow streams (7) are circulated by the moving conductive element (1) to receive heat from contacting the surface of the heated conductive element (1). Furthermore, the conductive element (1) directs the generated warm air flow streams (8) outwardly from the electromagnetic induction air heater system (10) to the surrounding air such that the warm air flow streams convect with the surrounding air to heat a desired space or building, thereby providing greater energy efficiency in warming colder air as compared with traditional electric heaters with static heating elements that passively warm the surrounding air and requiring more energy in the process.

The embodiment of FIG. 2 illustrates a plurality of conductive elements, for example conductive elements (1) and (9), where each conductive element (1), (9) rotates about a corresponding rotational axis (5) at different rotational velocities and varied rates of angular acceleration. Each conductive element (1), (9) for the embodiment of FIG. 2 is composed of material selected from the group consisting of: magnetic material with a high level of magnetic permeability, a metallic material featuring high level of thermal conductivity, an alloy material featuring both a high level of thermal conductivity and magnetic permeability, and a metallic material featuring both a high level of thermal conductivity and magnetic permeability. Each conductive element (1) is rendered a variety of configurations for both heating and directing hot air away from the electromagnetic induction air heater system (10) such as, among others, a round plate, a plurality of fan blades, an arrangement of shaped blades that form a cylindrical shape, a round helix, and a square helix, etc. The conductive element (1) and an induction element (2) are positioned such that the induction element (2) is placed in either an adjacent plane with or in parallel to each conductive element (1), (9). The power supply (3) is coupled to the induction element (2). As electric current is applied by the power supply (3) to the induction element (2), each conductive element (1), (9) turns on its own rotational axis (5) by the driver (4), at a constant angular velocity or at a variable angular velocity.

Optionally, a nonconductive element (12) may be placed in alignment with the rotational axis (5) and either between the induction element (2) and at least one conductive element (1), (9), adjacent to at least one conductive element (1), (9) or perpendicular to the edges of the induction element (2). In one embodiment, as shown in FIG. 2, the nonconductive element (12) comprises a directional discharger for channeling the warm air flow streams (8) away from the conductive element (1) in a predetermined direction. In one embodiment, the nonconductive element (12) is rendered in a variety of general configurations selected from the group consisting of: a round plate, a flan blade, a plurality of fan blades, an arrangement of shaped blades that form a cylindrical shape, at least one blade configuration, a round plate with at least one fan blade, a cylindrical core with a plurality of fan blades extending from the core, a volumetric geometrical shape with a plurality of fan blades extending from the core, a planar geometrical shape, a frame, a volumetric geometrical shape, a volumetric geometrical shape with groves, a volumetric geometrical shape with perforations, a hollowed volumetric geometrical shape, a round helix, and a square helix.

With further reference to the embodiment of FIG. 2, the magnetic induction field applied by the induction element (2) to each conductive element (1), (9) rotating within the field establishes on the surface of each revolving conductive element (1), (9) a very high temperature warming that is regulated by a temperature control system (6) to avoid, among other applications, catastrophic heating of the element driver (5) coupled to each conductive element (1), (9). The cold air flow streams (7) are circulated by each of the moving conductive elements (1), (9) to receive heat from contacting the surface of each respective heated conductive element (1), (9). Furthermore, each conductive element (1), (9) directs the generated warm air flow streams (8) outwardly from the electromagnetic induction air heater system (10) to the surrounding air such that the warm air flow streams convect with the surrounding air to heat a desired space or building, thereby providing a major efficiency in warming colder air as compared with traditional electric heaters with static heating elements.

The embodiment of FIG. 3 illustrates a conductive element (1) comprising an arrangement of shaped blades that form a cylindrical shape. The conductive element (1) rotates about a corresponding rotational axis (5) at different rotational velocities and varied rates of angular acceleration. The conductive element (1) for the embodiment of FIG. 1 is composed of material selected from the group consisting of: magnetic material with a high level of magnetic permeability, a metallic material featuring high level of thermal conductivity, an alloy material featuring both a high level of thermal conductivity and magnetic permeability, and a metallic material featuring both a high level of thermal conductivity and magnetic permeability. The conductive element (1) and an induction element (2) are positioned such that the induction element (2) is placed in either an adjacent plane with or in parallel to the conductive element (1). The power supply (3) is coupled to the induction element (2). As electric current is applied by the power supply (3) to the induction element (2), the conductive element (1) turns on its own rotational axis (5) by the driver (4), at a constant angular velocity or at a variable angular velocity. The magnetic induction field applied by the induction element (2) to the conductive element (1) rotating within the field establishes on the surface of the revolving conductive element (1) a very high temperature warming that is regulated by a temperature control system (6) to avoid, among other applications, catastrophic heating of the element driver (5) coupled to the conductive element (1). The cold air flow streams (7) are circulated by the moving conductive element (1) to receive heat from contacting the surface of the heated conductive element (1). Furthermore, the conductive element (1) directs the generated warm air flow streams (8) outwardly from the electromagnetic induction air heater system (10) to the surrounding air such that the warm air flow streams convect with the surrounding air to heat a desired space or building, thereby providing a major efficiency in warming colder air as compared with traditional electric heaters with static heating elements.

Although the present invention has been described in detail, it should be understood that various changes, substitutions, and alterations could be made hereto without departing from the spirit and scope of the invention as defined by the appended claims.

I claim:

1. An electromagnetic induction air heater system (10) comprising:
a conductive element (1),
the conductive element (1) warming cold air flow streams (7) received by the electromagnetic induction air heater system (10);
a driver (4) coupled to the conductive element (1),
the driver (4) applies an angular velocity to the rotate the conductive element (1) about a rotational axis (5);
an induction element (2) positioned close to the conductive element (1);
a power supply (3),
the power supply coupled to the induction element (2) and provides electric current to the induction element (2) to generate a magnetic field about the induction element (2),
the conductive element (3) heats as it rotates within the magnetic field to transfer heat to warm the cold air flow streams (7);
a temperature control system (6),
the temperature control system (6) and the driver (4) each coupled to the power supply (3),
the temperature control system (6) regulates the high temperature heating of the conductive element (1) turning within the field, the cold air flow streams (7) are circulated about the surface of the conductive element (1) and directed by the moving conductive element (1) to thus generate warm air flow streams (8) from the conductive element (1).

2. The electromagnetic air heater system (10) according to claim 1 wherein the conductive element (1) is rendered in configurations selected from the group consisting of: a round plate, a flan blade, a plurality of fan blades, an arrangement of shaped blades that form a cylindrical shape, at least one blade configuration, a round plate with at least one fan blade, a cylindrical core with a plurality of fan blades extending from the core, a volumetric geometrical shape with a plurality of fan blades extending from the core, a planar geometrical shape, a frame, a volumetric geometrical shape, a volumetric geometrical shape with groves, a volumetric geometrical shape with perforations, a hollowed volumetric geometrical shape, a round helix, and a square helix.

3. The electromagnetic induction air heater system (10) according to claim 1 further comprising a plurality of conductive elements, wherein each conductive element from the plurality of conductive elements is aligned with the rotational axis (5) and positioned in parallel with the induction element (2).

4. The electromagnetic induction heater system (10) according to claim 1 further comprising at least one nonconductive element (12), the at least one nonconductive element is aligned with the rotational axis (5).

5. The electromagnetic induction air heater system (10) according to claim 4 wherein the at least one nonconductive element (12) comprises a directional discharger for channeling the warm air flow streams away from the conductive element (1) in a predetermined direction.

6. The electromagnetic air heater system (10) according to claim 4 wherein the nonconductive element (12) is rendered in configurations selected from the group consisting of: a round plate, a flan blade, a plurality of fan blades, an arrangement of shaped blades that form a cylindrical shape, at least one blade configuration, a round plate with at least one fan blade, a cylindrical core with a plurality of fan blades extending from the core, a volumetric geometrical shape with a plurality of fan blades extending from the core, a planar geometrical shape, a frame, a volumetric geometrical shape, a volumetric geometrical shape with groves, a volumetric geometrical shape with perforations, a hollowed volumetric geometrical shape, a round helix, and a square helix.

7. The electromagnetic induction air heater system (10) according to claim 1 wherein the induction element (2) is configured to conform to the shape of the conductive element (1) to optimize generation of eddy currents on the conductive element (1) while the conductive element (1) rotates within the magnetic field generated by the induction element (2).

8. The electromagnetic induction air heater system (10) according to claim 1 wherein the induction element (2) is rendered in configurations selected from the group consisting of: an induction winding, a flat induction winding, a round plate, a flan blade, a plurality of fan blades, at least one blade configuration, a planar geometrical shape, a frame, a flat geometrical form such as an elliptical, circular, rectangular, triangular form, a volumetric geometrical shape, a volumetric geometrical shape with groves, a volumetric geometrical shape with perforations, a hollowed volumetric geometrical shape, a round helix, and a square helix.

9. The electromagnetic air heater system (10) according to claim 1 wherein the conductive element (1) is composed of materials selected from the group consisting of: a magnetic material having a high level of magnetic permeability to increase the efficacy of conversion between electrical and heat energy as applied to the induction process, such as among others a metallic and a ceramic material; at least one material having a high thermal conductivity, such as among others at least one metallic material; at least one alloy material having a high thermal conductivity, such as among others at least one metallic alloy material; and a combination of at least one material having a high thermal conductivity and at least one material with a high level of magnetic permeability to increase the efficacy of conversion between electrical and heat energy.

10. A conductive element (1) for an electromagnetic induction air heater system (10), the conductive element (1) comprising:
at least one directional fin (13),
the at least one directional fin (13) provides increased surface area for cold air flow stream (7)contact with the conductive element (1),
the conductive element (1) warming cold air flow streams (7) received by the electromagnetic induction air heater system (10) to generate warm air flow streams (8),
the at least one directional fin (13) directs the generated warm air flow streams (8) outwardly from the electromagnetic induction air heater system (10) to the surrounding air; and
a driver (4) coupled to the conductive element (1),
the driver (4) applies an angular velocity to the rotate the conductive element (1) about a rotational axis (5),
the conductive element (3) heats as it rotates within a magnetic field to transfer heat to warm the cold air flow streams (7).

11. The conductive element (1) according to claim 10 wherein the at least one directional fin (13) facilitates generation of eddy or “Foucault” currents that arise throughout the conductive element (1) to raise the temperature about the surface of conductive element (1) to generate warm air flow streams (8) as the cold air flow streams (7) contact the at least one directional fin (13) and remaining surface of the conductive element (1).

12. The conductive element (1) according to claim 10 wherein the at least one directional fin (13) draws cold air flow streams (7) through the electromagnetic induction heater system (10).

13. The conductive element (1) according to claim 10 wherein the at least one directional fin (13) facilitates heat transfer to the cold air flow streams (7).

14. The conductive element (1) according to claim 10 wherein the at least one fin (13) directs the warm air flow streams (8) about a predetermined path created by the configuration the at least one fin (13) as the conductive element (1) rotates within the magnetic field.

15. The conductive element (1) according to claim 10 wherein the electromagnetic induction air heater system (10) further includes an induction element (2) positioned close to the conductive element (1), the induction element (2) generates a magnetic field for receiving the rotating conductive element (1).

16. The conductive element (1) according to claim 15 wherein the electromagnetic induction air heater system (10) further includes a power supply (3), the power supply (3) coupled to the induction element (2) and provides electric current to the induction element (2) to generate a magnetic field about the induction element (2).

17. The conductive element (1)according to claim 17 wherein the electromagnetic induction air heater system (10) further includes a temperature control system (6), the temperature control system (6) and the driver (4) each coupled to the power supply (3), the temperature control system (6) regulates the high temperature heating of the conductive element (1) turning within the field, the cold air flow streams (7) are circulated about the surface of the conductive element (1) and directed by the moving conductive element to thus generate warm air flow streams (8) from the conductive element (1).

18. The conductive element (1) according to claim 10 wherein the electromagnetic induction heater system (10) further includes at least one nonconductive element (12), the at least one nonconductive element is aligned with the rotational axis (5).

19. The conductive element (1) according to claim 18 wherein the at least one nonconductive element (12) comprises a directional discharger for channeling the warm air flow streams (8) away from the conductive element (1) in a predetermined direction.

20. A method for warming cold air flow streams (8) comprising the steps of:
applying an angular velocity to rotate the conductive element (1) about a rotational axis (5), via a driver (4) coupled to the conductive element (1);
supplying electric current to an induction element (2) to generate a magnetic field about the induction element (2);
heating the conductive element (1) with eddy or “Foucault” currents as the conductive element (1) rotates within the magnetic field;
drawing cold air streams (7) to the conductive element (1) and transferring heat from the conductive element (1) to warm the cold air flow streams (7); and
circulating, via the moving conductive element (1), the cold air flow streams (7) about the surface of the conductive element (1) to generate warm air flow streams (8) and directing the warm air flow streams (8) from the conductive element (1) with the moving conductive element (1).
